(19) United States
(12) Patent Application Publication
(10) Pub. No.: US 2008/0159160 A1
(43) Pub. Date: Jul. 3, 2008

(54) METHOD OF DYNAMIC PERSISTANCE CONTROL IN WIRELESS COMMUNICATION

(76) Inventors: DEEPAK DAS, Arlington, MA (US); JUNG AH LEE, Pittstown, NJ (US)

Correspondence Address: MARK W. SINCELL;Suite 1100, Williams, Morgan & Amerson, P.C., 10333 Richmond, Houston, TX, 77042, US

(21) Appl. No.: 11/618,121

(22) Filed: Dec. 29, 2006

(51) Int. Cl. H04Q 7/00

(52) U.S. Cl. 370/252

(57) ABSTRACT

The present invention provides a method of wireless communication. One embodiment of the method includes determining a persistence parameter for at least one packet transmission based upon information indicative of a congestion level.

### BACKGROUND OF THE INVENTION

1. Field of the Invention

This invention relates generally to communication systems, and, more particularly, to wireless communication systems.

2. Description of the Related Art

Mobile units communicate with a conventional wireless communication system over an air interface between the mobile unit and one or more base stations or Node-Bs. The air interface supports a number of shared and/or dedicated channels such as data channels, signaling channels, broadcast channels, paging channels, and the like. For example, a random access channel is a shared channel that multiple mobile units may use to transmit information over the air interface. When a slot in the random access channel becomes available, more than one mobile unit may attempt to transmit packets using the slot, which may result in a collision between the transmitted packets. Collisions typically result in one or more of the packets failing to be successfully received and/or decoded by the base station. The base station may send a positive acknowledgment (ACK) in response for the successfully received packet. However, if the mobile units do not receive an ACK, more than one mobile unit may retransmit the packet in the same access slot and the multiple retransmitted packets may again collide, leading to further retransmissions.

Wireless communication systems typically implement a persistence algorithm to attempt to reduce collisions between retransmitted packets and thereby increase the overall throughput and stability of the wireless communication system. A persistence algorithm consists of determining a “back off,” which is the time delay between potential transmissions and/or retransmissions of the same packet, and the “persistence,” which determines the probability that a mobile unit will actually retransmit the packet at the time (or access slot) determined by the back off. For example, the back off time for the r-th retransmission of a packet may be determined by the Poisson arrival rate. If the Poisson arrival rate for the initial transmission of the data packets is given by λ₀, then the Poisson arrival rate for the r-th retransmission of the packet, λ(r), may be given by:

λ(r)=λ₀f(p),

where the parameter p is a back off rate and f(p) is a selected function of the back off rate. Exemplary functions that may be used to determine the Poisson arrival rate for the r-th retransmission include an exponential back off, a linear back off, a g-law back off, and a step-function back off. To determine whether to retransmit the packet in the current retransmission cycle determined by the back off, the mobile unit may compute a random number and compare this random number to the persistence value. If the random number is smaller than the persistence value, the mobile unit may retransmit the packet and, if the random number is larger than the persistence value, the mobile unit may not retransmit the packet.

Persistence values are typically determined by mobile units based on parameters that are assigned by the wireless communication system. For example, the Universal Mobile Telecommunications System (UMTS) implements Code Division Multiple Access (CDMA) protocols such as W-CDMA, which defines different access service classes for the mobile units. For example, UMTS W-CDMA may establish up to eight access service classes that may be defined according to certain Quality of Service classes. Each mobile unit may be assigned to one of the access service class based upon the quality of service (QoS) class of the mobile unit. For example, the mobile unit may transmit a message such as a radio resource control (RRC) connection request to a base station, which may then establish one or more associated access service classes in the radio resource control layer.

The base station may then signal the available access service classes to the mobile unit. For example, the base station may transmit a CMAC-CONFIG-REQ to a media access control (MAC-c) layer in the mobile unit. The MAC-c layer in the mobile unit may then select a specific access service class from the set of available access service classes according to the MAC logical channel priority. Each access service class has an associated persistence, which may be determined by the mobile unit based on the selected access service class. For example, the persistence value may be calculated based on a dynamic persistence level N=1,2, . . . , 8 and a persistence scaling factor sᵢ={0.2, 0.3, . . . , 0.9) using the equation:

$${P}_{i} = \{ \begin{matrix}1 & i = 0 \\ {2}^{- ( N - 1 )} & i = 1 \\ {s}_{i} {2}^{- ( N - 1 )} & i = 2 , 3 , … , 7\end{matrix}$$

Values for the dynamic persistence levels and/or the persistence scaling factors are typically transmitted to the mobile units. For example, values of the dynamic persistence levels and/or the persistence scaling factors may be broadcast in System Information Block (SIB) types 5 and 7.

Conventional persistence control algorithms do not, however, account for changing conditions in the wireless communication system. For example, conventional persistence control algorithms do not account for variations in congestion levels, backlogs, system loads, and the like. Consequently, conventional persistence control algorithms may not be able to modify the various persistence parameters to reduce congestion levels in the system, backlogs associated with mobile units and/or base stations, and/or system loads.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method is provided for wireless communication. One embodiment of the method includes determining a persistence parameter for at least one packet transmission based upon information indicative of a congestion level.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates one exemplary embodiment of a wireless communications system and, in accordance with the present invention; and

FIG. 2 conceptually illustrates one exemplary embodiment of a portion of a base station, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

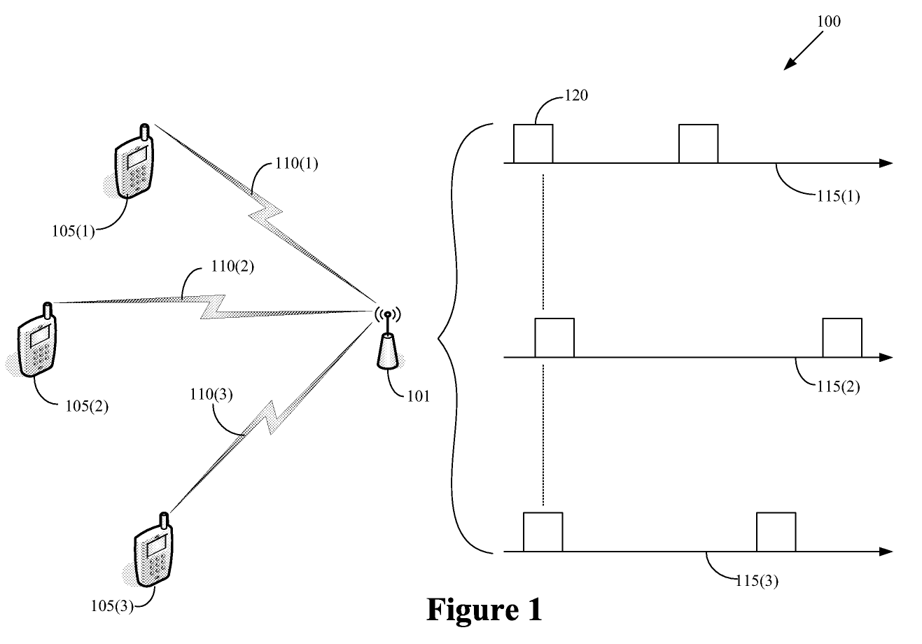

FIG. 1 conceptually illustrates one exemplary embodiment of a wireless communications system 100. In the illustrated embodiment, the wireless communications system 100 may provide wireless connectivity according to a third generation wireless communication protocol such as the Code Division Multiple Access (CDMA) protocol defined in ANSI TIA/EIA/IS-2000 standard. However, persons of ordinary skill in the art having benefit of the present disclosure should appreciate that the present invention is not limited to CDMA protocols and alternative embodiments may implement other wireless communication protocols in combination with and/or in addition to the CDMA protocol. In the illustrated embodiment, the wireless communication system 100 includes one or more base stations 101. However, the present invention is not limited to base stations 101 and alternative embodiments may implement other devices for providing wireless connectivity such as Node-Bs, access points, access networks, base station routers, and the like.

The base station 101 may provide wireless connectivity to end-user devices such as one or more mobile units 105(1-3) using one or more wireless communication links over air interfaces 110(1-3). In the interest of clarity, the indices (1-3) may be dropped when the mobile units 105 and/or air interfaces 110 are being referred to collectively. However, the indices (1-3) may be used when referring to the mobile units 105 and/or air interfaces 110 individually or to a subset of the mobile units 105 and/or air interfaces 110. The same convention may be used with regard to other indices that distinguish between components that share an identifying numeral. The mobile units 105 may be any type of mobile unit 105 including, but not limited to, a cellular telephone, a personal data assistant, a laptop computer, a smart phone, a pager, a text messaging device, a Global Positioning System (GPS) device, a network interface card, a desktop computer, and the like.

The wireless communication links between the mobile units 105 and the base station 101 include numerous channels, such as a random access channel. Random access channels are shared channels and so any or all of the mobile units 105 may attempt to transmit information over the air interfaces 110 using open access slots in the random access channel. Consequently, more than one mobile unit 105 may attempt to transmit a packet of information in each available slot of the random access channel. For example, the sequences of packet transmissions on a random access channel between the base station 101 and the mobile units 105 as indicated on the axes 115. In the illustrated embodiment, a first access slot (at the left-hand side of the axes 115) in the random access channel becomes available and all three mobile units 105 attempt to transmit a packet 120 (only one packet indicated by a numeral in FIG. 1). Portions of the packets 120 transmitted in the first slot overlap or collide and so the three packets 120 need to be retransmitted.

The mobile units 105 may determine when to retransmit the packets using a persistence algorithm that determines a back off time and a persistence parameter. As used herein and in accordance with common usage in the art, the term “back off” will be understood to refer to the time delay between potential transmissions and/or retransmissions of the same packet and the term “persistence” will be understood to be a parameter value that determines the probability that a mobile unit will actually retransmit the packet at the time (or access slot) determined by the back off. In the illustrated embodiment, the mobile units 105 utilize a value of the persistence parameter that is determined at the base station 101 (or at some other entity within the wireless communication system 100) and then provided to the mobile units 105. The value of the persistence parameter is determined based on the current operational state of the wireless communication system 100. In one embodiment, the persistence parameter is determined based upon a congestion level within the wireless communication system 100, which may be determined using measures of the backlog in the wireless communication system 100 and/or a load of the wireless communication system 100.

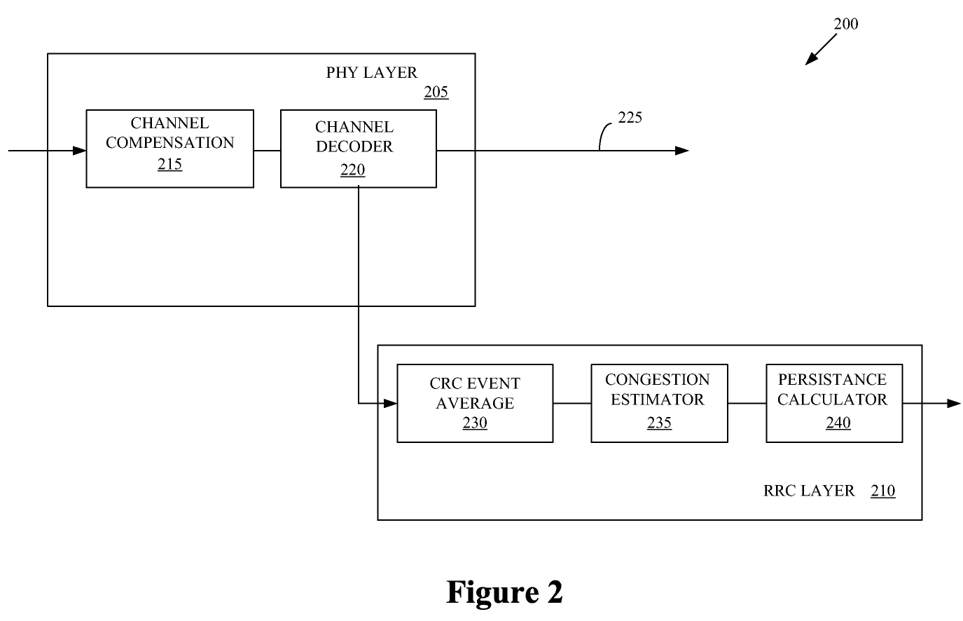

FIG. 2 conceptually illustrates one exemplary embodiment of a portion 200 of a base station. In the illustrated embodiment, a portion 200 includes a physical (PHY) layer 205 and a radio resource control (RRC) layer 210 of the base station 200. The physical layer 205 provides functionality for transparent transmission of a bit stream between data link entities, such as data link layers in base stations and/or mobile units. The radio resource control layer 210 provides information transfer services and may be responsible for controlling configuration of radio interface layers such as the data link layer and the physical layer 205. However, persons of ordinary skill in the art having benefit of the present disclosure should appreciate that the exemplary portion 200 is intended to be illustrative and not to limit the present invention.

The physical layer 205 includes a channel compensation unit 215 that may receive a de-spread signal indicative of symbols received from one or more mobile units over a shared channel such as a random access channel. The channel compensation unit 215 provides a partially processed signal to a channel decoder 220 for attempted decoding of the symbols received from the one or more mobile units. If the channel decoder 220 successfully decodes one or more of the symbols, then the channel decoder 220 may provide the decoded random access channel message to other portions of the base station 200, as indicated by the arrow 225. The channel decoder 220 may also provide information indicative of transmission errors and/or other failures to decode one or more of the symbols. For example, the channel decoder 220 may provide information indicative of failed cyclic redundancy checks to a cyclic redundancy check (CRC) event averaging unit 230 in the RRC layer 210.

The CRC event averaging unit 230 may accumulate CRC errors reported by a channel decoder 220 over selected time windows and an average the CRC errors over these windows. For example, the averaging interval may be selected depending on a required adaptation speed. Short averaging windows may be used to control access when the number of CRC errors is expected to change relatively rapidly and longer averaging windows may be used to increase the accuracy and/or stability of the averaging. In one embodiment, the CRC errors may be reported and/or averaged separately for mobile units that are assigned to different access service classes. The averaged CRC error rate, and/or a forward error rate estimated by dividing accumulated CRC errors for a given time by the number of random access channel messages that are received during the same time, may then be reported to a congestion estimator 235.

The congestion estimator 235 may estimate a congestion level within the wireless communication system based on information provided by the physical layer 205, such as the CRC error rate. In one embodiment, the congestion estimator 235 may estimate the congestion level using an estimate of backlog in a wireless communication system, which may be determined based upon the averaged CRC error rate. For example, a forward error rate of random access channel messages can be a good indicator of backlog within the wireless communication system. The congestion estimator 235 may therefore use the estimate of the forward error rate provided by the PHY layer 205 to determine the backlog estimate. Alternatively, the congestion estimator 235 may estimate the forward error rate by dividing accumulated CRC errors (reported by the PHY layer 205) for a given time by the number of random access channel messages that are received during the same time. In one embodiment, the forward error rate is computed by averaging the CRC errors overall detected users for all available resources (e.g., the available access lots and signatures for each access service class).

However, persons of ordinary skill in the art having benefit of the present disclosure should appreciate that other estimates of the backlog may also be used. In one alternative embodiment, the congestion estimator 235 may determine a forward error rate using a virtual decoder (not shown). For example, a virtual decoder may be used to decode random access channel messages and then estimate a ratio of signal energy per bit to additive noise and interference (Eb/No) for the decoded message. The forward error rate may then be obtained from link-level results or from a lookup table that relates Eb/No to the forward error rate. A uniformly-distributed random number between 0 and 1 may then be generated and compared with the forward error rate. An error event is generated when the random number does not exceed the forward error rate.

The backlog Bᵢ(n) for each access service class ASCI may be estimated as:

Bᵢ(n)≈FER×(Number of available resources for ASCI),

The persistence value may then be determined using:

$${P}_{i} = \{ \begin{matrix}{P}_{0} & {\tilde{B}}_{i} < {δ}_{1} \\ {P}_{0} {e}^{- ( {\tilde{B}}_{i} - {δ}_{1} )} / K & {δ}_{1} < {\tilde{B}}_{i} < {δ}_{2} \\ 0 & {\tilde{B}}_{i} \geq {δ}_{2}\end{matrix}$$

where the normalization factor P₀ is given by the equation:

$${P}_{0} = \frac{1}{δ + K [ 1 - {e}^{- ( {δ}_{2} - {δ}_{1} ) / K} ]} ,$$

and the parameter K controls the slope of the load line. The values of the parameters K, δᵢ, and δ₂ may be determined theoretically, empirically and/or by experiment.

A system load may also be used to estimate the congestion level. In one embodiment, congestion estimator 235 may estimate the system load based upon a number of acknowledged preambles associated with transmissions by mobile units in each access service class. For example, the load may be estimated for each access service class as the time average of all acknowledged preambles:

Lᵢ(n)≈(Number of acknowledged preambles per frame)×(Averaging window in frames)/(Number of available resources in an ASCI).

Alternatively, the congestion estimator may receive an estimate of the system load computed elsewhere, such as the physical layer 205. If the estimated load is above a selected threshold value, the persistence value may be adjusted to limit access to the random access channel. The particular threshold value, as well as the adjustments to the persistence value, are matters of design choice and may be determined theoretically, empirically and/or by experiment.

Embodiments of the dynamic persistence algorithms described herein may adapt the persistence values based on indicators of congestion such as load, backlog, or collision probability. Dynamic adaptation algorithms may be implemented as either a global adaptation mechanism or a local adaptation mechanism. Global adaptation algorithms estimate overall congestion of the system at the receiver and controls the overall load based on this global congestion estimate. Local adaptation algorithms adjust retransmission at each transmitting station based on the transmitting stations congestion level and/or collision experience. Conventional load control algorithms, such as the UMTS persistence algorithm, are based on broadcast information. This does not allow dynamic adaptation based on backlog or other congestion indicators. In contrast, embodiments of the dynamic persistence algorithms described herein may be used to control the load dynamically depending on backlog estimation, which may facilitate fast and accurate load control to the desired load level.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the invention. Accordingly, the protection sought herein is as set forth in the claims below.

What is claimed:

1. A method of wireless communication, comprising:
determining a persistence parameter for at least one packet transmission based upon information indicative of a congestion level.

2. The method of claim 1, wherein determining the persistence parameter based upon the information indicative of the congestion level comprises determining the persistence parameter based upon at least one of a backlog and a load.

3. The method of claim 2, wherein determining the persistence parameter comprises determining the persistence parameter based upon at least one of a backlog and a load for at least one access service class associated with at least one base station.

4. The method of claim 2, wherein determining the persistence parameter based upon the backlog comprises estimating a forward error rate based upon at least one cyclic redundancy check error associated with at least one received random access channel message.

5. The method of claim 4, wherein determining the persistence parameter based upon the backlog comprises averaging the cyclic redundancy check errors for at least one detected user, at least one access slot, and at least one access service class signature.

6. The method of claim 2, wherein determining the persistence parameter based upon the backlog comprises estimating a forward error rate using a virtual decoder.

7. The method of claim 6, wherein estimating the forward error rate using the virtual decoder comprises:
estimating a ratio of signal energy per bit to additive noise and interference (Eb/No); and
estimating the forward error rate using the estimated ratio and at least one of a link-level results and a lookup table.

8. The method of claim 2, wherein estimating the congestion level based upon the load comprises estimating the load based on a number of acknowledged preambles and a number of available resources.

9. The method of claim 8, wherein estimating the congestion levels comprises estimating at least one loaded for at least one access service class based upon a number of acknowledged preambles and a number of available resources associated with said at least one access service class.

10. The method of claim 1, wherein determining the persistence parameter based upon the information indicative of the congestion level comprises determining the persistence parameter based upon a value of the congestion level averaged over a selected time period.

11. The method of claim 1, comprising providing information indicative of the determined persistence parameter to at least one mobile unit.
